(19) United States
(12) Patent Application Publication
(10) Pub. No.: US 2006/0201931 A1
(43) Pub. Date: Sep. 14, 2006

(54) Touch sensible display device, and driving apparatus and method thereof

(75) Inventors: Joo-Hyung Lee, Gyeonggi-do (KR); Kee-Han Uh, Gyeonggi-do (KR); Young-Jun Choi, Gyeonggi-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/404,254

(22) Filed: Apr. 12, 2006

(30) Foreign Application Priority Data
Mar. 13, 2005 (KR) 10-2005-003068

(51) Int. Cl. H05B 1/02

(52) U.S. Cl. 219/497

(57) ABSTRACT

A display device according to an embodiment of the present invention includes: a display panel including a plurality of image scanning lines and a plurality of sensor scanning lines; a plurality of display circuits connected to the image scanning lines; a plurality of sensing circuits connected to the sensor scanning lines and outputting sensor output signals according to an external touch; an image scanning driver applying image scanning signals to the image scanning lines; a sensor scanning driver applying sensor scanning signals to the sensor scanning lines; and a signal controller controlling the image scanning driver and the sensor scanning driver to operate at different time periods.

### BACKGROUND OF THE INVENTION

(a) Field of the Invention

The present invention relates to a display device and driving apparatus and method thereof.

(b) Description of Related Art

A liquid crystal display (LCD) includes a pair of panels provided with pixel electrodes and a common electrode and a liquid crystal layer with dielectric anisotropy interposed between the panels. The pixel electrodes are arranged in a matrix and connected to switching elements such as thin film transistors (TFTs) such that they receive image data voltages row by row. The common electrode covers entire surface of one of the two panels and it is supplied with a common voltage. A pixel electrode and corresponding portions of the common electrode, and corresponding portions of the liquid crystal layer form a liquid crystal capacitor that as well as a switching element connected thereto is a basic element of a pixel.

An LCD generates electric fields by applying voltages to pixel electrodes and a common electrode and varies the strength of the electric fields to adjust the transmittance of light passing through a liquid crystal layer, thereby displaying images.

Recently, an LCD incorporating sensors has been developed. The sensors sense the change of pressure or incident light caused by a touch of a finger or a stylus and provides electrical signals corresponding thereto for the LCD. The LCD determines whether and where a touch exists based on the electrical signals. The LCD sends the information on the touch to an external device that may return image signals to the LCD, which are generated based on the information. Although the sensors may be provided on an external device such as a touch screen panel to be attached to the LCD, it may increase the thickness and the weight of the LCD and it may make it difficult to represent minute characters or pictures.

A sensor incorporated into an LCD may be implemented as a thin film transistor (TFT) disposed in a pixel displaying an image.

Small and middle sized LCD employ low-voltage driving of data voltages for reducing power consumption, where the level of the common voltage varies every horizontal period for polarity inversion. However, since signal lines transmitting sensing signals are capacitively coupled with the common electrode, the variation of the common voltage may distort the sensing signals. Accordingly, the sensing signals need to be read within one horizontal period when the common voltage is kept constant. However, the recent increase of the resolution may shorten a time for one horizontal period to decrease the time for reading the sensing signals. Then, the magnitude of the sensing signals and the signal-to-noise ratio (SNR) may be decreased. As a result, the read sensing signals may not include significant touch information.

### SUMMARY OF THE INVENTION

A display device according to an embodiment of the present invention includes: a display panel including a plurality of image scanning lines and a plurality of sensor scanning lines; a plurality of display circuits connected to the image scanning lines; a plurality of sensing circuits connected to the sensor scanning lines and outputting sensor output signals according to an external touch; an image scanning driver applying image scanning signals to the image scanning lines; a sensor scanning driver applying sensor scanning signals to the sensor scanning lines; and a signal controller controlling the image scanning driver and the sensor scanning driver to operate at different time periods.

The image scanning driver may apply the image scanning signals in a display time period, and the sensor scanning driver may apply the sensor scanning signals in a sensing time period.

The display circuits may be supplied with a common voltage swinging between a high level and a low level.

The common voltage may have a first period in the display time period and a second period in the sensing time period, and the first period and the second period of the common voltage may be different from each other. For example, the first period of the common voltage may be shorter than the second period of the common voltage.

The common voltage may have a first duty ratio in the display time period and a second duty ratio different from the first duty ratio in the sensing period. The first duty ratio of the common voltage may be substantially equal to 50%.

The sensor scanning signals may be supplied when the common voltage is kept constant.

The display device may further include a sensing signal processor reading the sensor output signals when the common voltage is kept constant.

The display device may further include a sensing signal processor reading the sensor output signals when the common voltage is in the longer one of the high level and the low level.

The display circuits may be supplied with a common voltage, and the common voltage may swing between a high level and a low level in the display time period and may be kept constant in the sensing time period.

A display device according to another embodiment includes: a display panel including a plurality of image scanning lines and a plurality of sensor scanning lines; a plurality of display circuits connected to the image scanning lines; a plurality of sensing circuits connected to the sensor scanning lines and outputting sensor output signals according to an external touch; an image scanning driver applying image scanning signals to the image scanning lines; a sensor scanning driver applying sensor scanning signals to the sensor scanning lines; a common voltage generator generating a common voltage and applying the common voltage to the display panel, the common voltage having a first period and a second period different from the first period within a frame time; and a signal controller controlling the image scanning driver, the sensor scanning driver, and the common voltage generator.

The image scanning driver may apply the image scanning signals when the common voltage has the first period, and the sensor scanning driver may apply the sensor scanning signals when the common voltage has the second period.

The first period of the common voltage may be shorter than the second period of the common voltage.

The common voltage in the second period may have a high level and a low level and durations of the high level and the low level may be different from each other.

The sensor output signals may be read during the duration of the longer one of the high level and the low level of the common voltage.

A method of driving a display device according to an embodiment of the present invention includes: dividing a frame into a display time period and a sensing time period; applying image scanning signals in the display time period; and applying sensor scanning signals in the sensing time period.

The method may further include: applying a common voltage having a first period in the display time period and a second period in the sensing time period, the second period being different from the first period.

The common voltage in the second period may have a high level and a low level having a different duration from the high level.

The method may further include: reading the sensor output signals when the common voltage has the longer one of the high level and the low level.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel including a photo sensing circuit of an LCD according to an embodiment of the present invention;

FIG. 3 is an equivalent circuit diagram of a pixel including a pressure sensing circuit of an LCD according to an embodiment of the present invention;

FIG. 4 is a schematic diagram of an LCD according to an embodiment of the present invention;

FIG. 5 is a timing chart of various signals in an LCD according to an embodiment of the present invention;

FIG. 6 is a block diagram of an LCD according to another embodiment of the present invention;

FIG. 7 is an exemplary timing chart of the LCD shown in FIG. 6; and

FIG. 8 is another exemplary timing chart of the LCD shown in FIG. 6.

### DETAILED DESCRIPTION OF THE PREFERRED EMBODIMENTS

The present invention now will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

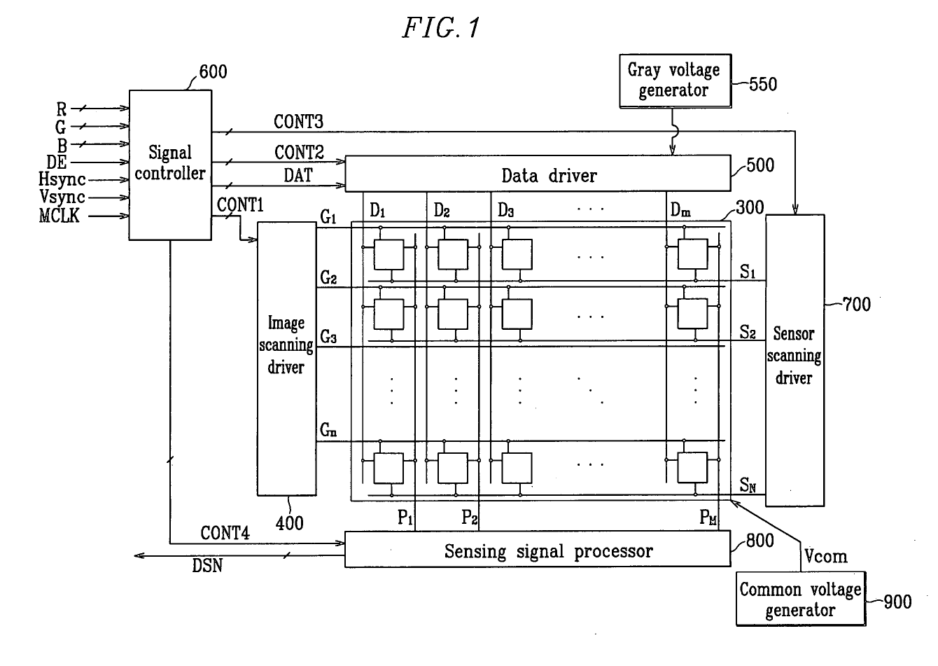

A liquid crystal display as an example of a display device according to an embodiment of the present invention now will be described as an example of a touch detectable display device in detail with reference to FIGS. 1, 2, 3 and 4.

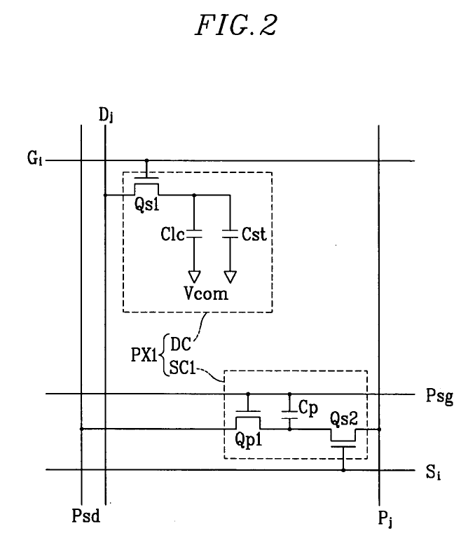

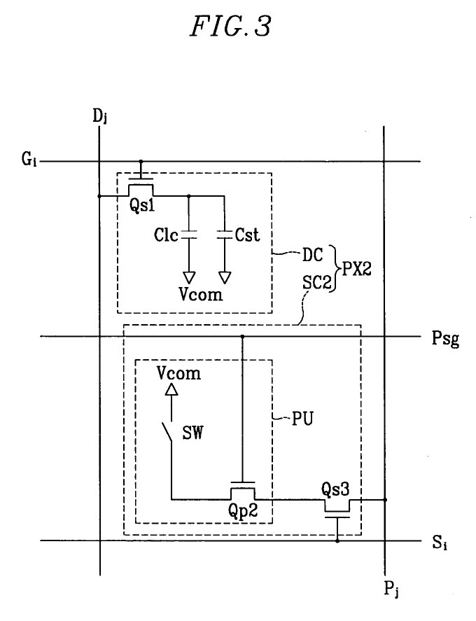

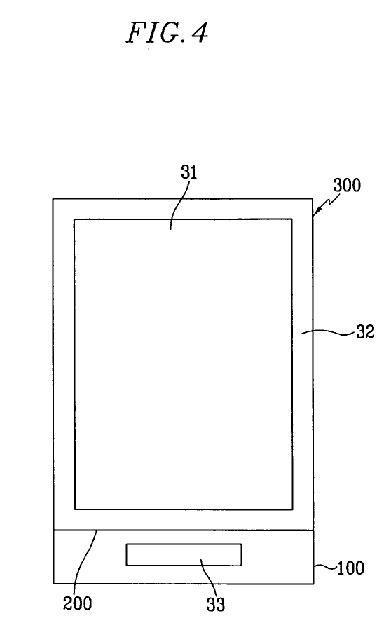

FIG. 1 is a block diagram of an LCD according to an embodiment of the present invention, FIG. 2 is an equivalent circuit diagram of a pixel including a photo sensing circuit of an LCD according to an embodiment of the present invention, FIG. 3 is an equivalent circuit diagram of a pixel including a pressure sensing circuit of an LCD according to an embodiment of the present invention, and FIG. 4 is a schematic diagram of an LCD according to an embodiment of the present invention.

Referring to FIG. 1, an LCD according to an embodiment includes a liquid crystal (LC) panel assembly 300, an image scanning driver 400, an image data driver 500, a sensor scanning driver 700, a common voltage generator 900, and a sensing signal processor 800 that are coupled with the panel assembly 300, a gray voltage generator 550 coupled to the image data driver 500, and a signal controller 600 controlling the above elements.

Referring to FIGS. 1-3, the panel assembly 300 includes a plurality of display signal lines G₁-Gₙ and D₁-Dₘ, a plurality of sensor signal lines S₁-S_{N}, P₁-P_{M}, Psg and Psd, and a plurality of pixels PX. The pixels PX are connected to the display signal lines G₁-Gₙ and D₁-Dₘ and the sensor signal lines S₁-S_{N}, P₁-P_{M}, Psg and Psd and arranged substantially in a matrix.

The display signal lines include a plurality of image scanning lines G₁-Gₙ transmitting image scanning signals and a plurality of image data lines D₁-Dₘ transmitting image data signals.

The sensor signal lines include a plurality of a plurality of sensor scanning lines S₁-S_{N} transmitting sensor scanning signals, a plurality of sensor data lines P₁-P_{M} transmitting sensor data signals, a plurality of control voltage lines Psg transmitting a sensor control voltage, and a plurality of input voltage lines Psd transmitting a sensor input voltage.

The image scanning lines G₁-Gₙ and the sensor scanning lines S₁-S_{N} extend substantially in a row direction and substantially parallel to each other, while the image data lines D₁-Dₘ and the sensor data lines P₁-P_{M} extend substantially in a column direction and substantially parallel to each other.

Referring to FIGS. 2 and 3, each pixel PX, for example, a pixel PX1 or PX2 in the i-th row (i=1, 2, . . . , n) and the j-th column (j=1, 2, . . . , m) includes a display circuit DC connected to display signal lines Gᵢ and Dⱼ and a photo sensing circuit SC1 connected to sensor signal lines Sᵢ, Pⱼ, Psg and Psd or a pressure sensing circuit SC2 connected to sensor signal lines Sᵢ, Pⱼ and Psg. However, only a given number of the pixels PX may include the sensing circuits SC1 or SC2. In other words, the concentration of the sensing circuits SC1 and SC2 may be varied and thus the number N of the sensor scanning lines S₁-S_{N} and the number M of the sensor data lines P₁-P_{M} may be varied and may be different from the number n of the image scanning lines G₁-Gₙ and the number m of the image data lines D₁-Dₘ, respectively.

For example, it is assumed that the resolution of the LCD is equivalent to QVGA (quarter video graphics array) having 240×320 dots. When the resolution of the sensing circuits SC1 and SC2 is equivalent to QVGA, one sensing circuit is assigned to every three pixels PX. When the resolution of the sensing circuits SC1 and SC2 is equivalent to QQVGA (quarter QVGA) having 120×160 dots, one sensing circuit is assigned to every twelve pixels PX. Here, one dot is a basic unit for representing a color, includes a set of three pixels, for example, red, green, and blue pixels.

The sensing circuits SC1 and SC2 may be separated from the pixels PX and may be provided between the pixels PX or in a separately provided area. A photo sensing circuit SC1 and a pressure sensing circuit SC2 may be connected to the same sensor data line Pⱼ, but it is preferable that the photo sensing circuit SC1 and the pressure sensing circuit SC2 are connected to different sensor data lines.

The display circuit DC includes a switching element Qs1 connected to an image scanning line Gᵢ and an image data line Dⱼ, and a LC capacitor Clc and a storage capacitor Cst that are connected to the switching element Qs1. The storage capacitor Cst may be omitted.

The switching element Qs1 has three terminals, i.e., a control terminal connected to the image scanning line Gᵢ, an input terminal connected to the image data line Dⱼ, and an output terminal connected to the LC capacitor Clc and the storage capacitor Cst.

The LC capacitor Clc includes a pair of terminals and a liquid crystal layer (not shown) interposed therebetween and it is connected between the switching element Qs1 and a common voltage Vcom. The two terminals of the LC capacitor Clc may be disposed on a lower panel 100 and an upper panel 200 of the panel assembly 300. One of the two terminals is often referred to as a pixel electrode, and the other of the two terminals is often referred to as a common electrode. The common electrode covers an entire area of the upper panel 200 and is supplied with a common voltage Vcom.

The storage capacitor Cst assists the LC capacitor Clc and it is connected between the switching element Qs1 and a predetermined voltage such as the common voltage Vcom. The storage capacitor Cst may include the pixel electrode and a separate signal line, which is provided on the lower panel 100 and overlaps the pixel electrode via an insulator. Alternatively, the storage capacitor Cst includes the pixel electrode and an adjacent image scanning line called a previous image scanning line, which overlaps the pixel electrode via an insulator.

For a color display, each pixel PX uniquely represents one of primary colors (i.e., spatial division) or each pixel PX sequentially represents the primary colors in turn (i.e., temporal division) such that a spatial or temporal sum of the primary colors is recognized as a desired color. An example of a set of the primary colors includes red, green, and blue colors. In an example of the spatial division, each pixel PX includes a color filter representing one of the primary colors in an area facing the pixel electrode 190.

The photo sensing circuit SC1 shown in FIG. 2 includes a photo sensing element Qp1 connected to a control voltage line Psg and an input voltage line Psd, a sensor capacitor Cp connected to the photo sensing element Qp1, and a switching element Qs2 connected to a sensor scanning line Sᵢ, the photo sensing element Qp1, and a sensor data line Pⱼ.

The photo sensing element Qp1 has three terminals, i.e., a control terminal connected to the control voltage line Psg to be biased by the sensor control voltage, an input terminal connected to the input voltage line Psd to be biased by the sensor input voltage, and an output terminal connected to the switching element Qs2. The photo sensing element Qp1 includes a photoelectric material that generates a photocurrent upon receipt of light. An example of the photo sensing element Qp1 is a thin film transistor having an amorphous silicon or polysilicon channel that can generate a photocurrent. The sensor control voltage applied to the control terminal of the photo sensing element Qp1 is sufficiently low or sufficiently high to keep the photo sensing element Qp1 in an off state without incident light. The sensor input voltage applied to the input terminal of the photo sensing element Qp1 is sufficiently high or sufficiently low to keep the photocurrent flowing in a given direction. The photocurrent flows from the photo sensing element Qp1 toward the switching element Qs2 as a result of the application of the sensor input voltage and it also flows into the sensor capacitor Cp to charge the sensor capacitor Cp.

The sensor capacitor Cp is connected between the control terminal and the output terminal of the photo sensing element Qp1. The sensor capacitor Cp stores electrical charges output from the photo sensing element Qp1 to maintain a predetermine voltage. The sensor capacitor Cp may be omitted in other embodiments.

The switching element Qs2 also has three terminals, i.e., a control terminal connected to the sensor scanning line Sᵢ, an input terminal connected to the output terminal of the photo sensing element Qp1, and an output terminal connected to the sensor data line Pⱼ. The switching element Qs2 outputs a sensor output signal to the sensor data line Pⱼ in response to the sensor scanning signal from the sensor scanning line Sᵢ. The sensor output signal is a sensing current from the photo sensing element Qp1. However, the sensor output signal may be a voltage stored in the sensor capacitor Cp.

The pressure sensing circuit SC2 shown in FIG. 3 includes a pressure sensing element PU connected to the common voltage Vcom and a control voltage line Psg, and a switching element Qs3 connected to a sensor scanning line Sᵢ, the pressure sensing element PU, and a sensor data line Pⱼ.

The pressure sensing element PU includes a pressure switch SW connected to the common voltage Vcom and a driving transistor Qp2 connected between the switch SW and the switching element Qs3.

The pressure switch SW connects the driving transistor Qp2 to the common voltage Vcom under a pressure following a touch exerted on the panel assembly 300. For example, the pressure may make an electrode (not shown) supplied with the common voltage Vcom approach a terminal of the driving transistor Qp2 to be in contact therewith. However, the switch SW may use another physical quantity for connecting the driving transistor Qp2 to the common voltage Vcom and in this case, the pressure sensing element PU and the pressure switch SW may be referred to as other names.

The driving transistor Qp2 has three terminals, i.e., a control terminal connected to the control voltage line Psg to be biased by the sensor control voltage, an input terminal connected to the switch SW, and an output terminal connected to the switching element Qs3. The driving transistor Qp2 generates and outputs an electrical current upon receipt of the common voltage Vcom from the switch SW.

The switching element Qs3 also has three terminals, i.e., a control terminal connected to the sensor scanning line Sᵢ, an input terminal connected to the output terminal of the driving transistor Qp2, and an output terminal connected to the sensor data line Pⱼ. The switching element Qs3 outputs the current from the driving transistor Qp2 to the sensor data line Pⱼ as a sensor output signal in response to the sensor scanning signal from the sensor scanning line Sᵢ.

The switching elements Qs1, Qs2 and Qs3, the photo sensing element Qp1, and the driving transistor Qp2 may include amorphous silicon or polysilicon thin film transistors (TFTs).

The pressure sensing circuit SC2 can correctly inform the existence of a touch, but it may not inform the precise position of the touch since the pressure following the touch may cover a wide area. On the contrary, the photo sensing circuit SC1 can inform the precise position of a touch of an object by sensing the variation of light illuminance caused by a shadow of the object, while it may not correctly inform the existence of the touch since the variation of illuminance can be generated by various causes other than a touch, for example, an object disposed near the panel assembly 300 but does not touch the panel assembly 300 may vary the light illuminance.

It is preferable that the resolution of the sensing circuits is as small as possible for reducing the time for processing the sensor output signals. In particular, the resolution of the pressure sensing circuits is preferably smaller than the resolution of the photo sensing circuits since the determination of the existence of a touch can be appropriately performed under a low resolution of the pressure sensing circuits.

One or more polarizers (not shown) are provided at the panel assembly 300.

Referring to FIG. 4, the panel assembly 300 includes a light blocking member 32 referred to as a black matrix that encloses a display area 31, and the pixels PX and most parts of the signal lines G₁-Gₙ, D₁-Dₘ, S₁-S_{N}, P₁-P_{M}, Psg and Psd are disposed in the display area 31. The upper panel 200 is smaller than the lower panel 100 to expose portions of the lower panel 100. The image data lines D₁-Dₘ extend into the exposed portions of the lower panel 100 to be connected to the image data driver 500. The image scanning lines G₁-Gₙ also extend into the exposed portions of the lower panel 100 to be connected to the image scanning driver 400 and the sensor scanning lines S₁-S_{N} also extend into the exposed portions of the lower panel 100 to be connected to the sensor scanning driver 700.

The gray voltage generator 550 generates two sets of gray voltages related to a transmittance of the pixels. The gray voltages in a first set have a positive polarity with respect to the common voltage Vcom, while the gray voltages in a second set have a negative polarity with respect to the common voltage Vcom.

The common voltage generator 900 generates the common voltage Vcom and supplies the common voltage Vcom to the panel assembly 300. The common voltage Vcom swings between a high level and a low level for polarity inversion, and has different periods in two time periods of each frame.

The image scanning driver 400 is connected to the image scanning lines G₁-Gₙ of the panel assembly 300 and synthesizes a gate-on voltage and a gate-off voltage to generate the image scanning signals for application to the image scanning lines G₁-Gₙ. The image scanning driver 400 may include a shift register including a plurality of stages aligned in series and may be integrated into the panel assembly 300 along with the signal lines G₁-Gₙ, D₁-Dₘ, S₁-S_{N}, P₁-P_{M}, Psg and Psd, the switching elements Qs1, Qs2 and Qs3, and the photo sensing elements Qp1.

The image data driver 500 is connected to the image data lines D₁-Dₘ of the panel assembly 300 and applies image data signals selected from the gray voltages to the image data lines D₁-Dₘ.

The sensor scanning driver 700 is connected to the sensor scanning lines S₁-S_{N} of the panel assembly 300 and synthesizes a gate-on voltage and a gate-off voltage to generate the sensor scanning signals for application to the sensor scanning lines S₁-Sₙ.

The sensing signal processor 800 is connected to the sensor data lines P₁-P_{M} of the display panel 300 and receives and analog-to-digital converts the sensor data signals from the sensor data lines P₁-P_{M} to generate digital sensor data signals DSN to be outputted to an external device. The sensor data signals carried by the sensor data lines P₁-P_{M} may be current signals and in this case, the sensing signal processor 800 converts the current signals into voltage signals before the analog-to-digital conversion. One sensor data signal carried by one sensor data line P₁-P_{M} at a time may include one sensor output signal from one switching elements Qs2 or Qs3 may include at least two sensor output signals outputted from at least two switching elements Qs2 or Qs3.

The signal controller 600 controls the image scanning driver 400, the image data driver 500, the sensor scanning driver 700, and the sensing signal processor 800, etc.

The processing units 500, 550, 600 and 800 may be incorporated into a single IC chip 33 mounted on the panel assembly 300 as shown in FIG. 4. However, the processing units 500, 550, 600 and 800 may be implemented as separate IC chips.

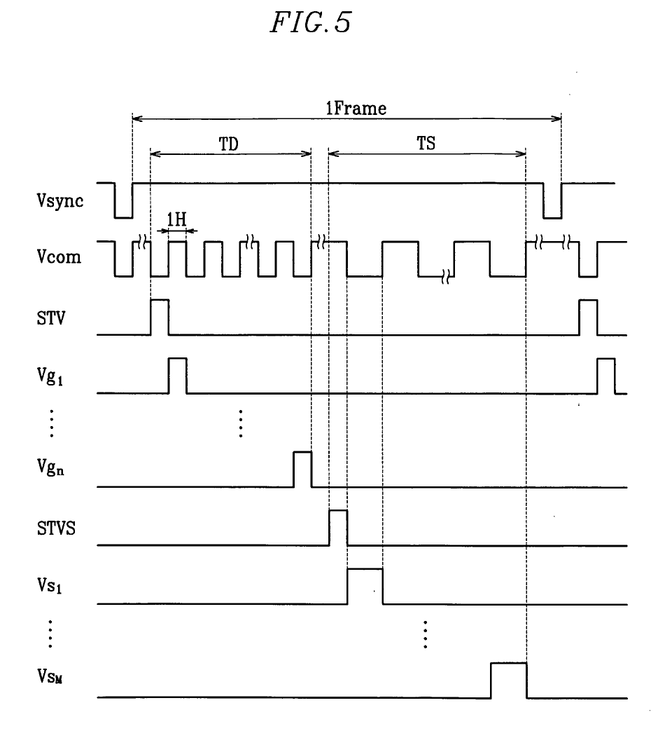

Now, the operation of the above-described LCD will be described in detail with reference to FIG. 5 as well as FIG. 1.

FIG. 5 is a timing chart of various signals in an LCD according to an embodiment of the present invention.

The signal controller 600 is supplied with input image signals R, G and B and input control signals for controlling the display thereof from an external graphics controller (not shown). The input control signals include a vertical synchronization signal Vsync, a horizontal synchronization signal Hsync, a main clock MCLK, and a data enable signal DE.

On the basis of the input control signals and the input image signals R, G and B, the signal controller 600 generates image scanning control signals CONT1, image data control signals CONT2, sensor scanning control signals CONT3, and sensor data control signals CONT4, and it processes the image signals R, G and B into image signals DAT suitable for the operation of the display panel 300. The signal controller 600 sends the scanning control signals CONT1 to the image scanning driver 400, the processed image signals DAT and the data control signals CONT2 to the image data driver 500, the sensor scanning control signals CONT3 to the sensor scanning driver 700, and the sensor data control signals CONT4 to the sensing signal processor 800.

The image scanning control signals CONT1 include an image scanning start signal STV for instructing the image scanning driver 400 to start image scanning and at least one clock signal for controlling the output time of the gate-on voltage of gate signals Vg₁-Vgₙ. The image scanning control signals CONT1 may include an output enable signal OE for defining the duration of the gate-on voltage.

The image data control signals CONT2 include a horizontal synchronization start signal STH for informing the data driver 500 of start of image data transmission for a group of pixels PX, a load signal LOAD for instructing the data driver 500 to apply the image data signals to the image data lines D₁-Dₘ, and a data clock signal HCLK. The image data control signal CONT2 may further include an inversion signal RVS for reversing the polarity of the image data signals (with respect to the common voltage Vcom).

The sensor scanning control signals CONT3 include an sensor scanning start signal STVS for instructing the sensor scanning driver 700 to start sensor scanning and at least one clock signal for controlling the output time of sensor scanning signals Vs₁-Vs_{N}.

The operation of the LCD can be divided into two periods, i.e., a display period TD and a sensing period TS. The LCD performs a display operation during the display period TD and performs a sensing operation during the sensing period TS.

In the display period TD, responsive to the image data control signals CONT2 from the signal controller 600, the image data driver 500 receives a packet of the digital image signals DAT for the group of pixels PX from the signal controller 600, converts the digital image signals DAT into analog image data signals by selecting the analog image data signals among the gray voltages from the gray voltage generator 550 corresponding to the digital image signals DAT, and applies the analog image data signals to the image data lines D₁-Dₘ.

The image scanning driver 400 applies the gate-on voltage to an image scanning line G₁-Gₙ in response to the image scanning control signals CONT1 from the signal controller 600, thereby turning on the switching transistors Qs1 connected thereto. The image data signals applied to the image data lines D₁-Dₘ are then supplied to the display circuit DC of the pixels PX through the activated switching transistors Qs1.

The difference between the voltage of an image data signal and the common voltage Vcom is represented as a voltage across the LC capacitor Clc, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance to display images.

By repeating this procedure by a unit of a horizontal period (also referred to as “1H” and equal to one period of the horizontal synchronization signal Hsync and the data enable signal DE), all image scanning lines G₁-Gₙ are sequentially supplied with the gate-on voltage, thereby applying the image data signals to all pixels PX to display an image for a frame.

During the sensing period TS, the sensor scanning driver 700 applies a high level voltage of the sensor scanning signals Vs₁-Vs_{N} to the sensor scanning lines S₁-S_{N} to turn on the switching elements Qs2 and Qs3 connected thereto in response to the sensing control signals CONT3. Then, the switching elements Qs2 and Qs3 output sensor output signals to the sensor data lines P₁-P_{M} to form sensor data signals, and the sensor data signals are inputted into the sensing signal processor 800.

The sensing signal processor 800 amplifies and filters the sensor data signals and coverts the amplified and filtered sensor data signals into digital sensor data signals DSN to be outputted to an external device

By repeating this procedure, all sensor scanning lines S₁-S_{N} are sequentially supplied with the high level voltage, thereby reading the sensor data signals to generate the digital sensor data signals DSN.

The external device appropriately processes the digital sensor data signals DSN to determine whether and where a touch exists and outputs information about the touch to the LCD.

When the next frame starts after one frame finishes, the inversion control signal RVS applied to the image data driver 500 is controlled such that the polarity of the image data signals is reversed (which is referred to as “frame inversion”). The inversion control signal RVS may be also controlled such that the polarity of the image data signals flowing in a data line are periodically reversed during one frame (for example, row inversion).

In the meantime, the common voltage Vcom has different periods between the display period TD and the sensing period TS as described above. The period of the common voltage Vcom is relatively short in the display period TD and relatively long in the sensing period TS. The period of the common voltage Vcom in the display period TD may be as short as possible unless the display characteristics such as the charging rate of the LCD is deteriorated. Then, the time for reading the sensor output signals may be increased to obtain large sensor data signals DSN having a large signal-to-noise ratio.

In the display period TD, the common voltage Vcom has a duty ratio of about 50% such that the durations of the high level voltage and the low level voltage are substantially equal to each other. However, the common voltage Vcom in the sensing period TS may have a duty ratio different from 50% such that the durations of the high level voltage and the low level voltage are substantially different from each other. For example, the duration of the high level of the common voltage Vcom may be longer or shorter than the duration of the lower level. The sensor output signals can be read when the voltage level of the common voltage Vcom is kept constant for preventing the distortion of the sensor output signals since the sensor output signals may be distorted when the voltage level of the common voltage Vcom varies. Therefore, the sensor output signals can be read during the duration of the longer one of the high level and the low level of the common voltage.

For example, it is assumed that the resolution of the display circuits DC is equal to 240×320 (dots), the resolution of the sensing circuits SC1 and SC2 is equal to 120×80 (dots), and the frame frequency is equal to 60 Hz (or the frame period is equal to 16.7 ms). When the durations of the display period TD and the sensing period TS are equal to about 8 ms, the period of the common voltage Vcom may be set to be equal to 50 micro seconds (=8 ms×2/320) in the display period TD, and to be equal to 100 micro seconds (=8 ms/80) in the sensing period TS. In the sensing period TS, when the common voltage Vcom has a duty ratio of 20% and the sensor output signals are read during the low level period of the common voltage Vcom, a time given for reading the sensor output signals is equal to about 80 micro seconds. As a comparative example, a conventional LCD performing display operation and sensing operation without separate display period and sensing period has a period of the common voltage Vcom equal to 100 micro seconds (=16 ms×2/320) and a time given for reading sensor output signals (equal to 50 micro seconds) is determined by a longitudinal resolution of display circuits DC regardless of the resolution of the sensing circuits SC1 and SC2. In this case, the reading time in the above-described example of the present invention is longer than the conventional example by about 30 micro seconds.

As for another example, it is assumed that the resolution of the display circuits DC is equal to 240×320 (dots), the resolution of the sensing circuits SC1 and SC2 is equal to 120×40 (dots), and the frame frequency is equal to 60 Hz (or the frame period is equal to 16.7 ms). When the durations of the display period TD and the sensing period TS are equal to about 8 ms, the period of the common voltage Vcom may be set to be equal to 50 micro seconds (=8 ms×2/320) in the display period TD, and to be equal to 200 micro seconds (=8 ms/40) in the sensing period TS. In the sensing period TS, when the common voltage Vcom has a duty ratio of 20% and the sensor output signals are read during the low level period of the common voltage Vcom, a time given for reading the sensor output signals is equal to about 160 micro seconds. This example provides a much longer time for reading sensor output signals by 110 micro seconds than the above-described conventional example.

As a result, the time for reading the sensor output signals can be increased as the longitudinal resolution of the sensing circuits SC1 and SC2 is lower than the longitudinal resolution of the display circuits DC.

Since the display period TD and the sensing period TS are separated from each other, the display operation and the sensing operation do not affect each other. The sensing operation may be performed in two or more frames.

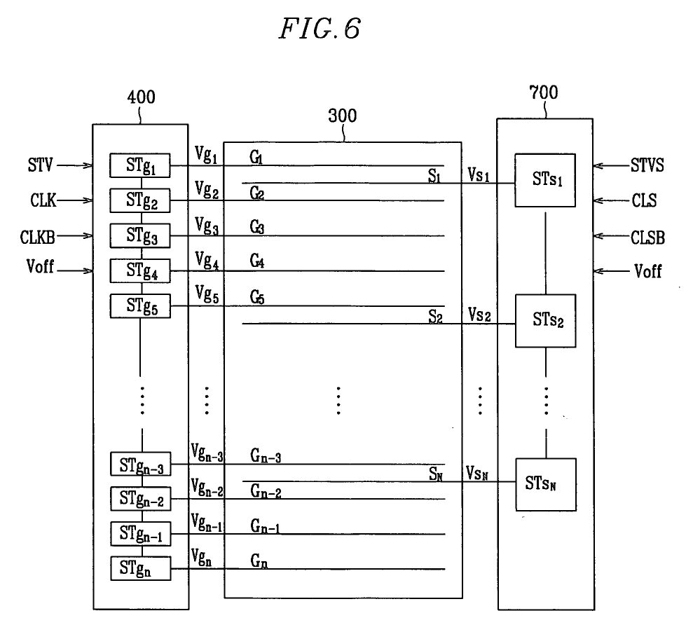

Now, an LCD according to another embodiment of the present invention will be described with reference to FIGS. 6, 7, and 8. The description of the LCD according to this embodiment will focus on the distinguishing features thereof as compared with the LCD shown in FIGS. 1-5.

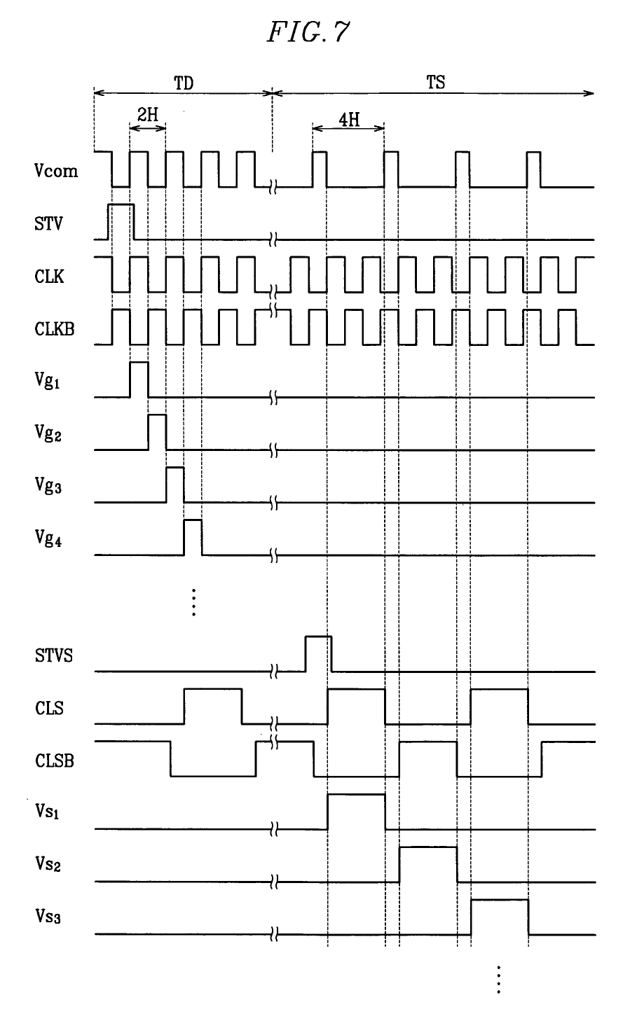

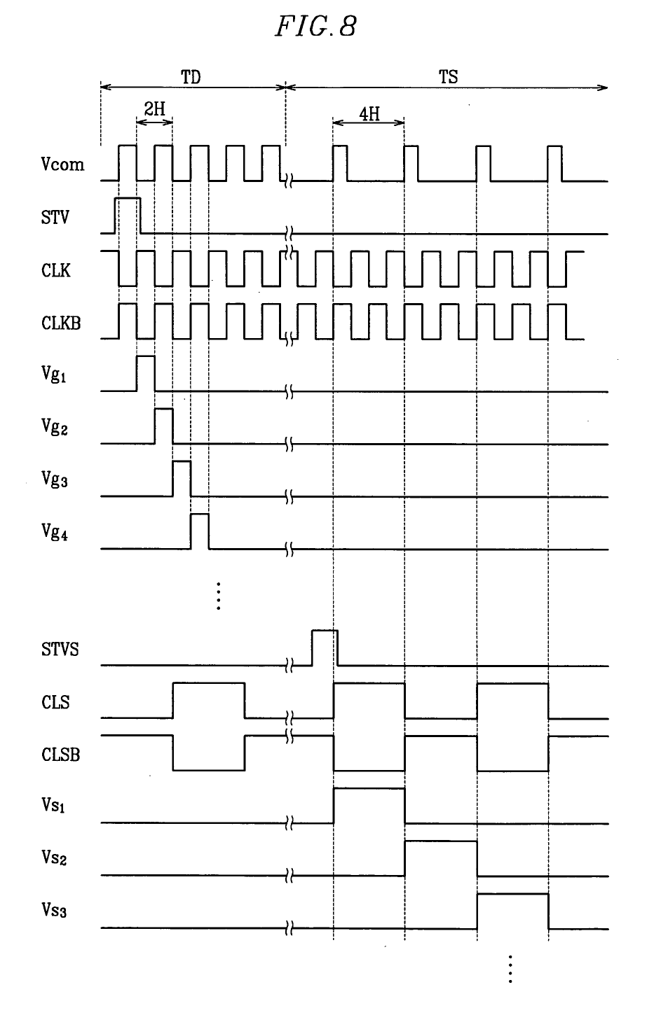

FIG. 6 is a block diagram of an LCD according to another embodiment of the present invention, FIG. 7 is an exemplary timing chart of the LCD shown in FIG. 6, and FIG. 8 is another exemplary timing chart of the LCD shown in FIG. 6.

Referring to FIG. 6, an LCD according to this embodiment includes a LC panel assembly 300, an image scanning driver 400, an image data driver 500, a sensor scanning driver 700 that are coupled with the panel assembly 300.

The panel assembly 300 includes a plurality of image scanning lines G₁-Gₙ, a plurality of sensor scanning lines S₁-S_{N}, a plurality of display circuits (not shown), and a plurality of sensing circuits (not shown).

The number N of the sensor scanning lines S₁-S_{N} is a quarter of the number n of the image scanning lines G₁-Gₙ. In other words, the longitudinal resolution of the sensing circuits is a quarter of the longitudinal resolution of the display circuits. The above-described example where the display resolution is equal to 240×320 dots and the sensing resolution is equal to 120×80 dots is an example of this embodiment.

Each of the sensor scanning lines S₁-S_{N} may include two branch lines connected to each other and a doubled number of the sensing circuits connected to the branch lines may be arranged in two rows. Then, since the number of the sensing circuits is increased, the characteristic deviations of the sensing circuits can be reduced and the signal-to-noise ratio can be increased to give more accurate sensing signals.

The image scanning driver 400 includes a plurality of stages STg₁-STgₙ connected in series. Each of the stages STg₁-STgₙ is coupled to an image signal line G₁-Gₙ, and outputs an image scanning signal Vg₁-Vgₙ based on an image scanning start signal STV, a pair of clock signals CLK and CLKB, and a gate-off voltage Voff.

The sensor scanning driver 700 includes a plurality of stages STs₁-STs_{N} connected in series. Each of the stages STs₁-STs_{N} is coupled to a sensor scanning signal S₁-S_{N}, and outputs a sensor scanning signal Vs₁-Vs_{N} based on an image scanning start signal STVS, a pair of clock signals CLS and CLSB, and a gate-off voltage Voff.

The image scanning driver 400 outputs a high level voltage in a period of 1H while the sensor scanning driver 700 outputs a high level voltage in a period of 4H.

Referring to FIG. 7, the common voltage Vcom has a period of 2H and a duty ratio of 50% in the display period TD, and has a period of 4H and a duty ratio of 20% in the sensing period TS. The pair of clock signals CLK and CLKB have a period of 2H, the duty ratio of 50%, and a phase difference of 180 degrees. The pair of clock signals CLK and CLKB has a period of 8H, the duty ratio of 40%, and a phase difference of 180 degrees.

In the display period TD, the image scanning signal Vg₁ becomes the gate-on voltage in synchronization with a rising edge of the clock signal CLK during the image scanning start signal STV, and the duration of the gate-on voltage is equal to a pulse width of the clock signal CLK. The image scanning signals Vg₂-Vgₙ become the gate-on voltage every 1H in synchronization with rising edges of the clock signals CLK and CLKB.

In the sensing period TS, the sensor scanning signal Vs₁ becomes the gate-on voltage in synchronization with a rising edge of the clock signal CLS during the sensor scanning start signal STVS, and the duration of the gate-on voltage is equal to a pulse width of the clock signal CLS. The sensor scanning signals Vs₂-Vs_{N} become the gate-on voltage every 4H in synchronization with rising edges of the clock signals CLS and CLSB. The sensor scanning signals Vs₁-Vs_{N} become the gate-on voltage during the low-level period of the common voltage Vcom (=16H/5), and during this time period, the sensing signal processor 800 reads the sensor data signals.

As described above, the LCD performs frame inversion. Therefore, the common voltage Vcom in the display period TD has a phase difference of 180 degrees relative to the image scanning signals Vg₁-Vgₙ between an odd frame and an even frame. However, since the sensing operation has no relation with the inversion, there is no phase difference in the common voltage Vcom relative to the sensor scanning signals Vs₁-Vs_{N} between odd and even frames, and the sensor scanning signals Vs₁-Vs_{N} become the gate-on voltage level in both odd and even frames when the common voltage Vcom is in low levels.

Referring to FIG. 8, the waveforms of the signals in the display period TD except for the phase of the common voltage Vcom are substantially the same as those shown in FIG. 7. Regarding the waveforms of the signals in the sensing period TS shown in FIG. 8, the common voltage Vcom has a period of 4H and a duty ratio of 20%. The clock signals CLS and CLSB have a period of 8H, a duty ratio of 50%, and a phase difference of 180 degrees relative to each other. Therefore, the sensor scanning signals Vs₁-Vs_{N} maintains the gate-on voltage level for 4H and there is no substantial gap between the gate-on voltage levels of adjacent sensor scanning signals Vs₁-Vs_{N}. Accordingly, each of the sensor scanning signals Vs₁-Vs_{N} maintains the gate-on voltage level for one period of the common voltage Vcom, that is, when the common voltage Vcom is from in a high level to in a low level. Therefore, the sensing signal processor 800 reads the sensor data signals only when the common voltage Vcom is in a low level for extracting correct sensor data signals. The sensor scanning driver 700 shown in FIG. 8 may include a lower number of thin film transistors than that shown in FIG. 7.

In the meantime, the duty ratio of the common voltage Vcom in the sensing period TS may be varied. The common voltage Vcom in the sensing period TS may be kept constant. The sensor data signals may be read when the common voltage Vcom is in a high level depending on the duty ratio of the common voltage Vcom.

The present invention can be also employed in other flat panel displays such as an organic light emitting diode (OLED) display and a plasma display panel (PDP).

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A display device comprising:
a display panel including a plurality of image scanning lines and a plurality of sensor scanning lines;
a plurality of display circuits connected to the image scanning lines;
a plurality of sensing circuits connected to the sensor scanning lines and outputting sensor output signals according to an external touch;
an image scanning driver applying image scanning signals to the image scanning lines;
a sensor scanning driver applying sensor scanning signals to the sensor scanning lines; and
a signal controller controlling the image scanning driver and the sensor scanning driver to operate at different time periods.

2. The display device of claim 1, wherein the image scanning driver applies the image scanning signals in a display time period, and the sensor scanning driver applies the sensor scanning signals in a sensing time period.

3. The display device of claim 2, wherein the display circuits are supplied with a common voltage swinging between a high level and a low level.

4. The display device of claim 3, wherein the common voltage has a first period in the display time period and a second period in the sensing time period.

5. The display device of claim 4, wherein the first period and the second period of the common voltage are different from each other.

6. The display device of claim 4, wherein the first period of the common voltage is shorter than the second period of the common voltage.

7. The display device of claim 4, wherein the common voltage has a first duty ratio in the display time period and a second duty ratio different from the first duty ratio in the sensing period.

8. The display device of claim 7, wherein the first duty ratio of the common voltage is substantially equal to 50%.

9. The display device of claim 3, wherein the sensor scanning signals are supplied when the common voltage is kept constant.

10. The display device of claim 3, further comprising a sensing signal processor reading the sensor output signals when the common voltage is kept constant.

11. The display device of claim 3, further comprising a sensing signal processor reading the sensor output signals when the common voltage is in the longer one of the high level and the low level.

12. The display device of claim 2, wherein the display circuits are supplied with a common voltage, and the common voltage swings between a high level and a low level in the display time period and is kept constant in the sensing time period.

13. A display device comprising:
a display panel including a plurality of image scanning lines and a plurality of sensor scanning lines;
a plurality of display circuits connected to the image scanning lines;
a plurality of sensing circuits connected to the sensor scanning lines and outputting sensor output signals according to an external touch;
an image scanning driver applying image scanning signals to the image scanning lines;
a sensor scanning driver applying sensor scanning signals to the sensor scanning lines;
a common voltage generator generating a common voltage and applying the common voltage to the display panel, the common voltage having a first period and a second period different from the first period within a frame time; and
a signal controller controlling the image scanning driver, the sensor scanning driver, and the common voltage generator.

14. The display device of claim 13, wherein the image scanning driver applies the image scanning signals when the common voltage has the first period, and the sensor scanning driver applies the sensor scanning signals when the common voltage has the second period.

15. The display device of claim 14, wherein the first period of the common voltage is shorter than the second period of the common voltage.

16. The display device of claim 14, wherein the common voltage in the second period has a high level and a low level and durations of the high level and the low level are different from each other.

17. The display device of claim 16, wherein the sensor output signals are read during the duration of the longer one of the high level and the low level of the common voltage.

18. A method of driving a display device including image scanning lines, sensor scanning lines, display circuits coupled to the image scanning lines, and sensing circuits coupled to the sensor scanning lines and outputting sensor output signals according to an external touch, the method comprising:
dividing a frame into a display time period and a sensing time period;
applying image scanning signals in the display time period; and
applying sensor scanning signals in the sensing time period.

19. The method of claim 18, further comprising:
applying a common voltage having a first period in the display time period and a second period in the sensing time period, the second period being different from the first period.

20. The method of claim 19, wherein the common voltage in the second period has a high level and a low level having a different duration from the high level.

21. The method of claim 20, further comprising:
reading the sensor output signals when the common voltage has the longer one of the high level and the low level.
